(19) United States
(12) Patent Application Publication
(10) Pub. No.: US 2008/0041245 A1
(43) Pub. Date: Feb. 21, 2008

(54) Solids Removal Press, Method and Feed System

(76) Inventor: Peter Judocus, Smolenaers (AU)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/631,428

(22) PCT Filed: Jul. 6, 2005
(86) PCT No.: PCT/AU05/00990

§ 371 Date: Feb. 20, 2007

(30) Foreign Application Priority Data
Jul. 7, 2004 (AU) 2004903743
Aug. 6, 2004 (AU) 2004904443

(51) Int. Cl. B30B 9/24

(52) U.S. Cl. 100/118

(57) ABSTRACT

A solids removal press, method and feed system for a liquid and solids mixture, the press including:—a conveyor system (10, 7, 18) having at least one pair of opposing surfaces defining a pressing chamber (40), the pressing chamber having an inlet opening (19) at one end thereof and a discharge opening (25) at the other end thereof, the inlet opening enabling the pressing chamber to be in fluid communication with a feed system (2) for providing a continuous, pressurised, feed of the liquid and solids mixture to the pressing chamber (40);—at least part of the pressing chamber (40) being permeate to liquid, enabling collection of liquid from the pressing chamber; the conveyor system conveying the mixture through the pressing chamber towards the discharge opening; wherein the pressing chamber includes at least one pressing zone (5, 6); characterised in that the feed system (2) directs a flow of the mixture through the inlet opening (19) and generally along at least one surface of the conveyor system, such that agglomerating solids are urged towards the discharge opening (25).

The present invention is generally directed to solids removal technology for separating solids from a liquid/solid solution, and in particular to a solids removal press, method and feeding system therefor. The present invention is applicable for use in the wine making industry and is described herein for this purpose. It is however to be appreciated that the present invention is also applicable for use in other industries and is not limited to its application in the wine making industry.

### BACKGROUND

In modern wine production, the harvested grapes initially undergo a crushing and de-stemming process and a juice separation process. At the crushing stage, the grapes are normally crushed and de-stemmed at the same time in a “crusher-de-stemmer” apparatus. This apparatus may for example be in the form of the perforated spinning cylinder having internal paddles or may be in the form of a roller crusher. The resultant mixture of red or white grape juice and crushed grapes is called the “Must”.

The Must needs to be further processed to separate the juice from the solids. This Must is typically placed in a press where pressure is applied to the Must to extract the juice. The juice is generally extracted from white grape Must immediately after crushing. Red wine Must is allowed to ferment to an extent prior to juice extraction.

While different types of presses can be used for the juice separation process, the primary objective is for the amount of juice extracted to be maximised with minimal contamination of the juice by debris and particulate material such as stalks, grape seeds and skins. It is also required that the press operate with no possibility of bacterial contamination of the Must and the final extracted juice. Shearing of the grape skins and seeds can result in excessive fines being produced and can result in the release of undesirable components into the extracted juice. It is therefore preferable to press the Must with minimal shear being applied to the grape skins and seeds.

In commercial wineries, it is also desirable to provide a press which is operable over a wide range of liquid to solid ratios, and that the press is capable of high throughput, preferably in excess of 10 tonnes per hour.

U.S. Pat. No. 4,236,445 discloses a grape press with continuous pressing belts, fed by a hopper. The press utilises a pair of continuous pressing belts driven in the same direction. The base belt is longer than the top belt and the belts are spaced to define a gap that decreases in width towards the top of the press, thereby defining pressing zones. The Must is delivered to the base belt from a hopper. The forward movement of this belt delivers solids and liquid material into the pressing zones.

A major drawback of the disclosed press is that the movement of Must into the actual pressing zone is primarily determined by the friction between the base belt and the grape Must, restricting the rate of throughput. Speeding up the base belt to achieve higher throughputs reduces the aforementioned friction and results in the belts freewheeling without picking up Must, or Marc (pressed and/or partially pressed Must), thereby stalling the action of the press and building up compacted solids in the hopper. Secondly, the hopper arrangement restricts the orientation of the press to angles of less than about 30 degrees, as shown in the Figures.

Patent publication no. WO9,422,666 additionally discloses a rotating drum having radial vanes in the hopper, in order to mechanically feed the Must into the chamber between the belts. It also discloses a stepped arrangement of increasing pressure sections along the chamber. In practice, the press may have similar operational problems to those mentioned in relation to U.S. Pat. No. 4,236,445. In addition, the initial pressing of the Must by the bottom end edge of the radial vanes may pack a wad of solids into the press base, clogging the belts and decreasing filtration efficiency, and hence separation of solids from liquids. Further, the stepped pressures of the pressing zones may cause resistance to movement through the pressing chamber. Each following pressing zone is a stepped narrower cavity than the pressing zone preceding it. This resistance requires the vane and belts to operate intermittently while Marc is coaxed up the chamber. This significantly affects the attainment of the high throughputs required for modern presses.

Patent publication no. WO 03/002335, discloses a juice press that utilises a pair of continuous pressing belts mounted and driven downward in a vertical array. The belts are spaced to define a gap that decreases in width towards the bottom of the press thereby defining pressing zones. The Must is delivered to the top of the defined gap by a narrow tube not directly connected to the press and a series of flexible barriers are spaced along each belt to help to hold down and retain the crushed grape skins as they pass through the pressing zones.

The juice press described in this international application also has a number of operational problems. Firstly, the introduction of the Must mixture into the top near the central axis of the press via an uncoupled narrow tube of significantly less cross sectional area than the throat of the press results in violent agitation of the Must. Movement of the belt barriers through the Must also results in violent agitation of the mixture. The result is an entrainment of air and release of volatiles from the Must. This has a detrimental effect on the quality of the final wine product, particularly white grape Must. The agitation also inhibits the downward motion of the solids material into the pressing zone. Belt barriers must therefore be installed to push down the solid material. The effectiveness of the belt barriers is hindered by the natural tendency of the grape skins in fermented red wine Must to float upwards. Also, when the Must mixture supplied to the press is mostly liquid in composition, the press cannot operate properly. This is because the liquid feeds straight through the press escaping out the bottom with little to no juice being captured by the press.

Finally, the agitation of the Must makes it very difficult to automate the pressing process because it is difficult to determine the concentration of solids in an agitated mixture, full of bubbles. It is then difficult to determine the proper timing of the actuation and speed of the belt drives.

It is therefore desirable to provide a solids removal press, method and feed system that overcomes one or more of above noted problems associated with prior art presses.

### SUMMARY OF THE INVENTION

One aspect of the present invention provides a solids removal press for a liquid and solids mixture, including:

a conveyor system having at least one pair of opposing surfaces defining a pressing chamber, the pressing chamber having an inlet opening at one end thereof and a discharge opening at the other end thereof, the inlet opening enabling the pressing chamber to be in fluid communication with a feed system for providing a continuous, pressurised, feed of the liquid and solids mixture to the pressing chamber;

at least part of the pressing chamber being permeable to liquid, enabling collection of liquid from the pressing chamber;

the conveyor system conveying the mixture through the pressing chamber towards the discharge opening,

wherein the pressing chamber includes at least one pressing zone; characterised in that the feed system directs a flow of the mixture through the inlet opening and generally along at least one surface of the conveyor system, such that agglomerating solids are urged towards the discharge opening.

Preferably, the general direction of flow of the mixture along the at least one surface has an angle of incidence with the said at least one surface of less than 60 degrees and more preferably is substantially parallel with the said at least one surface.

Preferably, the width of the flow of the mixture is substantially similar to the width of the at least one surface of the conveyor system. This ensures that agglomerating solids across the width of the conveyor system are all urged towards the discharge opening.

Preferably, the feed system includes a flow splitting guide, the flow splitting guide splitting the flow of the mixture into two streams and respectively directing each stream through the inlet opening and generally along respective opposing surfaces of the conveyor system, such that agglomerating solids are urged towards the discharge opening.

In a particularly preferred embodiment, the inlet opening of the press is located lower than the discharge opening and the at least one pair of opposing surfaces are orientated at an angle of less than 30 degrees from vertical. However, a press according to the first aspect of the invention may operate in any orientation.

Preferably, free run liquid is collected from the feed system and/or press at a location upstream of the at least one pressing zone. This free run liquid may be collected solely under pressure of the liquid solid mixture feed.

In a preferred embodiment of the invention, first press liquid is collected from a first pressing zone, second press liquid is collected from a second pressing zone and subsequent press liquid is collected from respective subsequent pressing zones. Individual collection of different grades of liquid is thereby enabled.

In a preferred embodiment, collection of liquid from the pressing chamber is conducted via one or more partial vacuum or vacuum systems. Such vacuum systems increase the rate at which liquid is collected from the pressing chamber and accordingly enhance the throughput rate of the press.

Preferably, one or more of the or each at least one pressing zones is adjustable to increase or decrease the distance between the at least one pair of opposing surfaces of the conveyor system. In a preferred embodiment, the angle of convergence a conveyor system having a single pair of opposing surfaces defining a pressing chamber may be varied, in order to regulate the pressure applied in each pressing zone. In another preferred embodiment, the pressure may be regulated by a backpressure device in cooperation with the pressing chamber outlet to maintain a selected predetermined pressure at the pressing chamber outlet, thereby maintaining a selected predetermined dryness of solids exiting the pressing chamber outlet.

In one preferred embodiment, the feed system may include at least one nozzle for directing the flow of the mixture. Alternately, a tube or tubes may inject the mixture into the pressing chamber. Preferably, the feed system provides a substantially laminar flow of the liquid and solids mixture to the pressing chamber.

The conveyor system may include an opposed pair of conveyor belts comprising a plurality of links, the belts driven by respective sprocket wheels, the teeth of which drive the belts and clean solids from the belts.

The opposing surfaces of the conveyor may have a plurality of protrusions, thereby preventing blinding. Gas injecting means may be provided, enabling control of the pressing chamber atmosphere.

A second aspect of the present invention provides a feed system for a solids removal press for a liquid and solids mixture, characterised in that the feed system directs a flow of the mixture through an inlet opening of the press and generally along at least one surface of a press conveyor system, such that agglomerating solids are urged towards a discharge opening of the press.

Preferred features of the feed system may be as described above in relation to the press.

In a preferred embodiment of the invention, free run liquid is taken off under pressure of the liquid and solid mixture feed. The free run liquid may be separately taken off at a first take-off point. The remaining liquid and solid mixture is conveyed downstream into a first pressing zone.

The feed system may be connected to a pressurised storage tank, or may be coupled to a feed line pressurised by a pump or other means, in order to provide a continuous pressurised feed of the mixture. The geometry of the feed system preferably promotes flow of the mixture in a direction substantially parallel to the direction of travel of the conveyor system. Hence, flow is generally along at least one surface of the conveyor system.

In one preferred embodiment of a conveyor system having one or more pairs of opposed conveyor belts, the angle of incidence of the flow with the respective surfaces of the conveyor belts is preferably less than 60 degrees and more preferably is substantially parallel to the respective surfaces, and to the direction of travel of the conveyor belts.

Where mixture flow is substantially parallel to the respective surfaces or the direction of travel of the conveyor system, agglomeration of solids on the conveyor system surfaces is reduced, the flow helping the press to be substantially self-cleaning, enhancing filtration efficiency by increasing the rate at which liquid may be taken off and enabling the press to run with high throughput.

This cleaning effect may be further improved by splitting the mixture flow into two or more streams, each stream flowing adjacent and substantially parallel to respective surfaces of a pair of opposed conveyor belts.

Such splitting may be achieved by the use of pipe work, flow splitting guides or directional devices such as tubes or nozzles. These pipes, guides or devices may also act to concentrate solids in a region downstream of the pipe, guide or device (and hence in mid-stream away from the conveyor surfaces), similar to sand depositing on the downstream or lee side of an island in a river. Flow splitting can also reduce flow through the central axis of the press, where the flow would not have a conveyor cleaning effect.

The feed system may also include a flow smoothing conduit to facilitate a generally laminar flow of the mixture into the chamber, the conduit having smooth internal walls for providing a smooth transition for the flow and delivering the mixture in a generally un-agitated state to the inlet opening of the pressing chamber. Commonly, the pressing chamber will be elongate.

The press may be positioned in any orientation as it is pressurised by the inlet feed flow. When the inlet opening is located at a level above the discharge opening, a sealing mechanism to prevent liquid flow through the discharge end may be required when the press operates at low solids levels. Orientations with the discharge end above the inlet end are preferred, and do not require a sealing mechanism. Gravity assists in the removal of liquid from such an upwardly operating press.

Solids may accumulate in the feed system when the press is operated with a horizontal or upward orientation. This allows a preferred embodiment of the press to be “self processing” such that when the mixture is mostly or entirely liquid in composition, free run liquid can simply escape through take off points located upstream of the first pressing zone, or through take off points located on non-conveyor surfaces of the pressing chamber, or through permeable conveyor belts so that the liquid level does not rise into the pressing zones.

When sufficient solids have accumulated within the feed system or pressing chamber, these solids may bridge between the opposed surfaces of the feed system or the conveyor system, slowing the flow of liquid therethrough. This results in increased fluid pressure, resulting in a surge of the solid material along the pressing chamber for further processing.

A scraper or brush or sprocket may be located adjacent to each conveyor to remove any solids adhering to the conveyors, this solid being returned to the pressing chamber for eventual discharge through the discharge opening.

The conveyor system may include at least one first opposed pair of continuously driven conveyor belts, to convey the liquid and solid mixture from the inlet opening towards the discharge opening.

Each belt may be permeable to liquid to thereby allow liquid flow there through. Further pairs of belts may also be provided in series with the first opposed pair of belts. For example, the first opposed pair of belts may be located in the free-run section, the belts travelling independently of a second opposed pair of belts defining the first pressing zone. The filtration efficiency, or rate of liquid extraction, may be increased by running the first opposed pair of belts faster than the second pair of opposed belts.

As a further example, a further opposed pair of belts may be located at 90 degrees from the first opposed pair of belts, forming an elongate chamber defined on four sides by the two pairs of opposed belts. This arrangement may improve the efficiency of the transport of the solids through the press.

An advantage of the present invention is that such a press continues to operate properly even when only liquid is fed to the press.

In addition to the improved throughput enabled by controlling the feed of mixture to the press, the agitation of the liquid and solid mixture being delivered to the press is controlled. In the case where the press is used to extract juice from a wine Must, this ensures that there is minimal entrainment of air or release of volatiles from the Must. Furthermore, this makes it easier to automatically control the operation of such a press as the solids contents of the mixture can be more readily determined.

### DESCRIPTION OF DRAWINGS

It will be convenient to further describe the invention with respect to the accompanying drawings which illustrate example embodiments of a solids removal press according to the present invention. Other embodiments of the invention are possible, and consequently, the particularity of the accompanying drawings is not to be understood as superseding the generality of the description of the invention.

In the drawings:

FIG. 1 is a schematic side view of a press according to one embodiment of the invention;

FIG. 2a is a cross sectional view of the press of FIG. 1;

FIG. 2b is a perspective view of a feed system according to the embodiment of FIGS. 1 and 2a;

FIG. 3 is a cross sectional view of a press according to another embodiment of the invention;

FIG. 4 is a cross sectional view of a further embodiment of the invention;

FIG. 5 is a side view of yet a further embodiment of the invention.

### DESCRIPTION OF PREFERRED EMBODIMENT

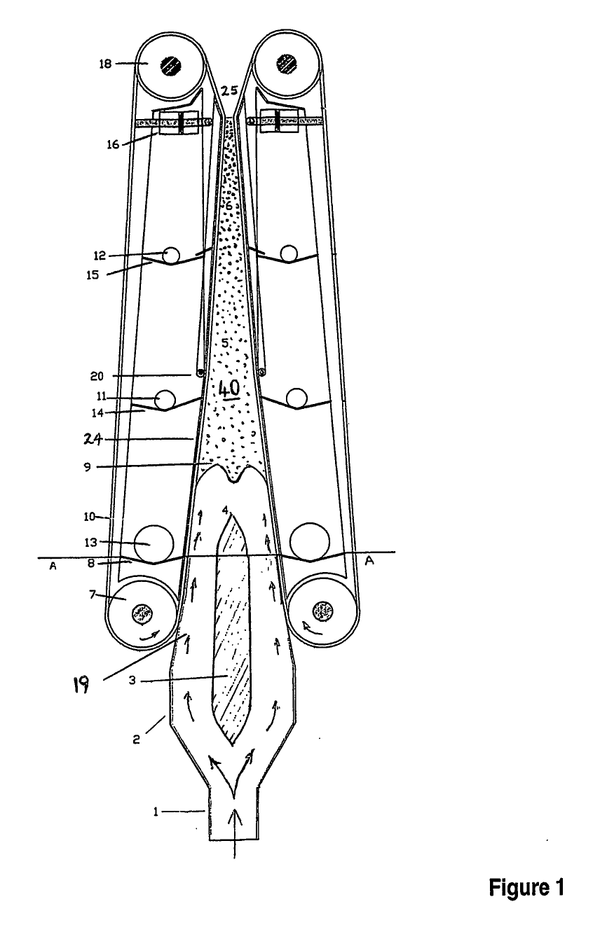

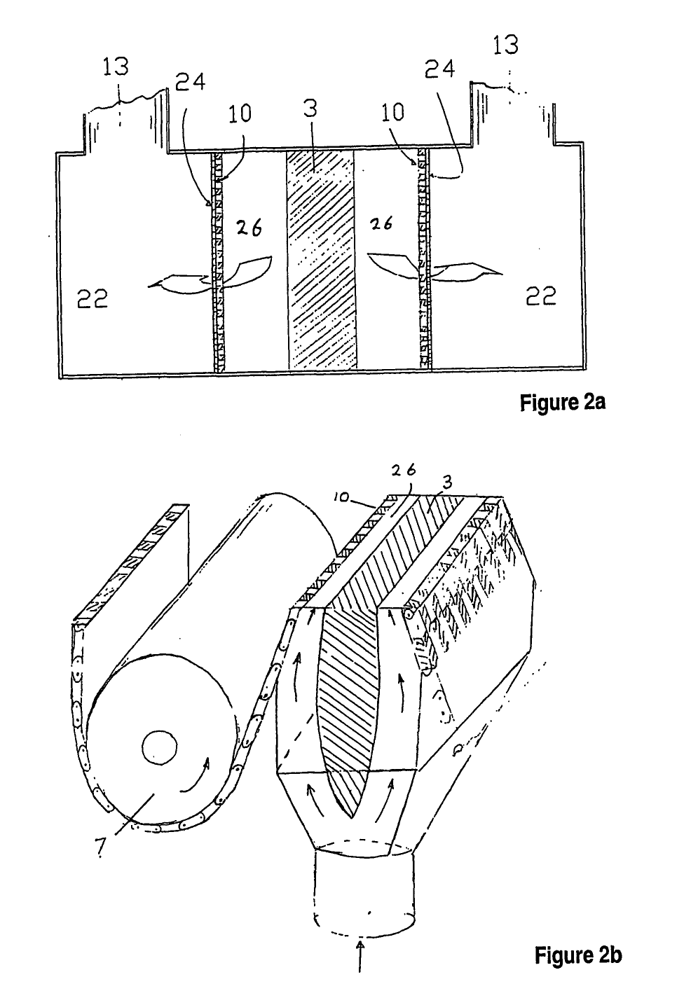

Referring initially to FIGS. 1, 2a and 2b, a solids removal press according to an embodiment of the present invention includes a feed line 1, delivering a continuous, pressurised feed of liquid and solids mixture to the feed system 2.

The press further includes a conveyor system including a pair of opposing continuously driven conveyor belts 10, each belt 10 being respectively supported on an idler drum or drive drum 7 and a drive drum 18. The opposed pair of belts 10 define a pressing chamber 40. Each continuous belt 10 travels along a permeable chamber wall 24 from an inlet opening 19 towards the discharge opening 25 of the pressing chamber 40. The belt 10 may be formed of chain links or from a permeable or perforated material. This allows liquid to pass through the belt 10 and through the chamber wall 24 for subsequent collection in collection chambers (the bottom surface of which is labelled 8, 14, 15 in FIG. 1) and drainage through drains 13, 11, 12.

The chamber walls 24 and conveyor system 7,10,18 are located between opposing panels (not shown) to thereby provide a front and back wall for the pressing chamber 40. The feed system 2 is coupled to and in fluid communication with the pressing chamber 40. Smooth transition of the flow from feed line 1 to feed system 2 and pressing chamber 40 is desirable.

Free run liquid may be collected from the pressing chamber 40 near the inlet opening 19, passing through permeable belts 10, and chamber walls 24, to collect in collector chamber 8 and subsequently draining through drain 13. Free run liquid is collected under fluid pressure before actual mechanical pressing or compacting of the liquid and solids mixture commences. The remaining liquids and solids mixture, now having a lower percentage of liquid, is conveyed towards the discharge opening 25 by the conveyor system.

As lateral width of the pressing chamber 40 deceases, solids are conveyed into the first pressing zone 5 and compacted. First press liquid is taken-off, or collected, into take-off point or collection chamber 14 and drained via drain 11.

A second pressing zone 6 is located downstream of the first pressing zone 5 and has corresponding take-off point 15 and drain 12. In alternative embodiments, more or fewer pressing zones may be provided.

The pressure applied may be varied, or held constant, as required. In the embodiment of FIG. 1, a part of the chamber wall 24 may be pivotable about a point 20 and operated by a spring 16 (or other mechanism, such as a piston), in order to maintain a predetermined gap, or predetermined pressure, at discharge opening 25. This ensures that solids exiting through the discharge opening 25 have been sufficiently pressed to the required degree to remove liquids. The dryness of the existing solids is thus controlled. In embodiments oriented such that the discharge opening is located at a level below the inlet opening, the spring or other mechanism may be operated to totally close the discharge opening 25 as may be required.

The feed system 2 includes a flow splitting guide 3 which splits the flow into two streams, altering feed line 1 flow from a circular cross section into two streams of rectangular cross section. Provision of an elongate flow splitting guide 3, as shown in FIG. 1, imparts some laminar characteristics to the flow, which is desirable.

As shown in the embodiment of FIG. 1, the flow splitting guide 3 may protrude through the inlet opening 19 and into the pressing chamber 40. The flow is directed generally along the surface of each conveyor belt 10 of the conveyor system and is substantially parallel to each belt 10. The flow assists in keeping the belts 10 free from agglomerating solids material as filtration takes place and free run liquid is collected.

By directing the flow adjacent to and along the length of each of the conveyor belt 10 surfaces, so that the general direction of flow has an angle of incidence of less than about 60 degrees with each conveyor belt 10 surface, any agglomerating solids that have accumulated in the feed system 2, pressing chamber inlet opening 19 or in the pressing chamber 40 upstream 4 of the first pressing zone 5, are urged downstream towards the discharge opening 25 of the pressing chamber 40, cleaning the conveyor belts 10 and increasing the liquid flow rate through the liquid permeable belts 10, which enables higher processing thoughput.

FIGS. 2a and 2b show a feed system with a flow splitting guide 3, which splits flow from a circular cross section into two streams of rectangular cross section 26. The flow width is substantially similar to the conveyor belt 10 width, providing a cleaning effect over the width of the belts 10.

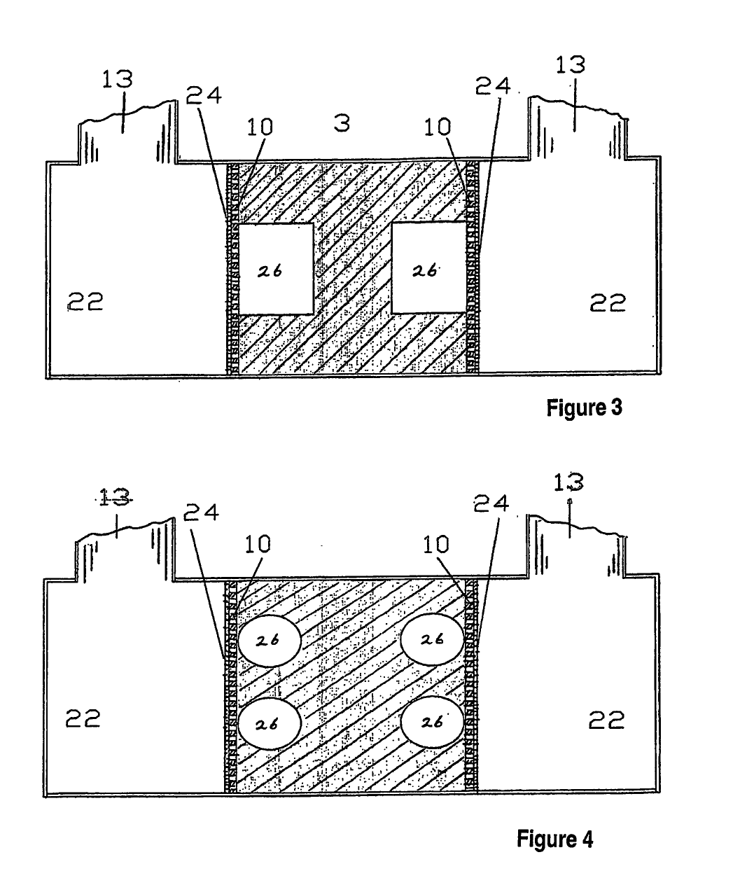

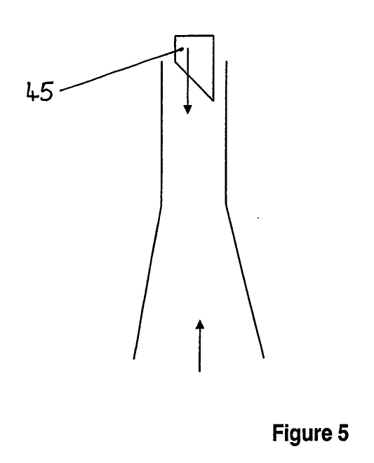

Other feed systems are possible. In another preferred embodiment, the flow may initially be split into two pipes of circular cross section which subsequently alter to a rectangular cross section. FIG. 3 shows a feed system in which the flow width is less than half the conveyor belt width. FIG. 4 shows another embodiment in which flow is split into four streams, two adjacent to each belt. These arrangements are also effective in assisting with keeping the conveyor belts clean.

It is preferable in the application of the press for wine Must that the flow into the pressing chamber 40 be at least partially laminar. This ensures that there is maximum belt cleaning and minimal disruption to the solid separation process. Minimal agitation also prevents the release of volatiles from the Must and facilitates control of the press.

In the preferred embodiment shown in FIG. 1, the inlet opening 19 is located below the discharge opening 25, the press and conveyor system operating upwardly. In preferred embodiments, the press is positioned such that its elongate axis is anywhere from 0° to 90° above the horizontal, and preferably between 30° to 90° above the horizontal in order to take advantage of gravity separation of the liquid when operating upwardly. However, a downwardly operating press also falls within the scope of the invention. Such a press requires a means to seal the discharge opening located at the bottom, in order to prevent un-pressed mixture falling straight through when the mixture has a high percentage of liquid. Once sufficient solids have built up in the press, the seal is no longer required, as the semi-pressed solids will prevent fall-through.

In the press of FIG. 1, the chamber walls 24 are perforated to allow liquid to flow through or filtrate into separate collection chambers 8, 14, 15 located behind the chamber walls 24, for collecting the liquid passing through the chamber walls. In a preferred embodiment of the press, the perforations represent an open area of at least 20%, more preferably 30 to 60% of the chamber wall 24. Each perforation may be a circle of between 1.5 to 6 mm in diameter or a slot having a width of between 1.5 to 4 mm. Drains 13, 11, 12 are respectively provided for each collection chamber for draining away the liquid from the press.

Solids from the liquid and solids mixture may accumulate in the feed system 2, or in the pressing chamber 40 upstream 4 of the first pressing zone 5. Liquid runs off through permeable conveyor belts 10 and chamber walls 24. Where the mixture is a wine Must, this liquid is the “free run juice”.

As the solids accumulate, they tend to block the conveyor belts 10, restricting liquid flow through belts 10 and chamber wall 24 into collection chamber 8. The liquid level in the pressing chamber therefore rises, urging solids further through the press. The solids form a bridge 9 between the opposed conveyor belts 10, enabling the belts 10 to effectively convey the solids into the first pressing zone 5, compacting the solids via mechanical pressing and collecting first press liquid.

When the liquid and solid mixture is primarily liquid, the free-run liquid is easily taken off, and the press does not flood. The press does not require priming with solid material, as solids will eventually be urged, either by flow from the feed system 2, or by conveyor belts 10, to bridge 9 between opposed surfaces and move into the pressing zone(s) for processing.

In another preferred embodiment, pressure in the pressing chamber is maintained by application of “back-pressure” to the device, rather than by provision of converging pressing chamber walls. As shown in FIG. 5, after an initially converging inlet section, the press maintains a constant lateral width (i.e. gap between conveyor surfaces) and a back pressure device 45 is provided.

The back pressure device 45 may be a piston having an angled face and be raised or lowered as required to adjust or maintain the pressure, and hence dryness of solids exiting the press. In a preferred embodiment, the piston is spring loaded and maintains a constant pressure at the pressing chamber outlet. This ensures that the exiting solids have been correctly pressed to the required level of dryness and that the correct amount of liquid has been collected. Hence, the physical position of the piston may vary during operation in order to maintain the constant pressure, for example where solids “clump” or are not yet sufficiently pressed.

The backpressure device may be adjusted, but in normal operation will be adjusted to a predetermined desired pressure for a given mixture to be pressed.

In a preferred embodiment, the press can be automatically run using a central control unit for controlling the flow rate of the mixture into the press, the actual travel speed of the drive belts 10 and the dryness of the solids at the press discharge end 25.

To minimise any chemical reactions with air taking place inside the press, the press can be injected with inert gases and thereby control oxidation of the wine Must passing through the press.

Each continuous belt may be supported by an idler drum or drive drum at one end and a drive drum at the opposing end thereof for driving the belt. It is also envisaged that each continuous belt be driven by a caterpillar drive mechanism located along the belt.

Cleaning arrangements such as scraper blades or brushes or cleaning sprays may be used to remove excess solids from the face of the belts. Alternatively, each belt may be formed by a series of belt links having openings therebetween to define an open latticework. Each drive drum may be in the form of a sprocket having teeth that engage the openings in the belt to thereby drive the belt. This arrangement also acts to push out any solids accumulated in the belt openings facilitating cleaning of the belts.

Each belt may further include other means on the belt face to facilitate solids pick-up or to maintain the permeability of the belts. This may be in the form of roughening, dimpling and press-outs, or may be in the form of a series of outwardly projecting members spaced along the belts.

Blinding may be prevented by providing protrusions on the belt face, for example triangular protrusions, which reduce the incidence of solids getting stuck in the conveyor belt face in the inlet area. By orienting the triangular protrusions such that the point of the protrusion points in the downstream direction, free flowing solids contacting the protrusion easily flow past the protrusion without becoming stuck on the chains. The solids will tend to be deflected by each protrusion slightly away from the belt surface, thereby reducing the incidence of blinding of the conveyor belt surface and further assisting with keeping the conveying surface free of agglomerating solids, particularly in the region upstream of the first pressing zone. This is important, as it is in this region that free run liquids are collected from the press, and throughput of the press is negatively affected where the permeable belt becomes clogged in this area. As solids compact and are carried by the conveyor system, the compacting solids may be picked up and carried along the conveyor by the protrusions for subsequent pressing.

Alternatively, the belts may be made of a permeable woven mesh or a permeable filter material.

1. A solids removal press for a liquid and solids mixture, including:
a conveyor system having at least one pair of opposing surfaces defining a pressing chamber, the pressing chamber having an inlet opening at one end thereof and a discharge opening at the other end thereof;
at least part of the pressing chamber being permeable to liquid, enabling collection of liquid from the pressing chamber;
the conveyor system conveying the mixture through the pressing chamber towards the discharge opening;
wherein the pressing chamber includes at least one pressing zone; wherein the inlet opening enables the pressing chamber to be in fluid communication with a feed system for providing a continuous, pressurized, feed of the liquid and solids mixture to the pressing chamber; and wherein the feed system includes director means for directing a flow of the mixture through the inlet opening and generally along at least one surface of the conveyor system, the directed flow thereby urging agglomerating solids towards the discharge opening of the press.

2. A press according to claim 1 wherein the general direction of flow of the mixture along the at least one surface has an angle of incidence with the said at least one surface of less than 60 degrees.

3. A press according to claim 1 wherein the general direction of flow along the at least one surface is substantially parallel with the said at least one surface.

4. A press according to claim 1 wherein the width of the flow of the mixture is substantially similar to the width of the at least one surface of the conveyor system.

5. A press according to claim 1 wherein the feed system includes a flow splitting guide, the flow splitting guide splitting the flow of the mixture into two streams and respectively directing each stream through the inlet opening and generally along respective opposing surfaces of the conveyor system, such that agglomerating solids are urged towards the discharge opening.

6. A press according to claim 1 wherein in use, the inlet opening is located lower than the discharge outlet and the at least one pair of opposing surfaces are oriented at an angle of less than 30 degrees from vertical.

7. A press according to claim 1 wherein free run liquid is collected from the feed system and/or press at a location upstream of the at least one pressing zone.

8. A press according to claim 1 wherein first press liquid is collected from a first pressing zone, second press liquid is collected from a second pressing zone, and subsequent press liquid is collected from respective subsequent pressing zones.

9. A press according to claim 1 wherein collection of liquid from the pressing chamber is conducted via one or more partial-vacuum systems.

10. A press according to claim 1 wherein collection of liquid from the pressing chamber is conducted via one or more vacuum systems.

11. A press according to claim 1 wherein one or more of the or each at least one pressing zones is adjustable to increase or decrease the distance between the at least one pair of opposing surfaces of the conveyor system.

12. A press according to claim 1 wherein the feed system includes at least one nozzle for directing the flow of the mixture.

13. A press according to claim 1 wherein the feed system provides a substantially laminar flow of the liquid and solids mixture to the pressing chamber.

14. A press according to claim 1 wherein a backpressure device cooperates with the pressing chamber outlet to maintain a selected predetermined pressure at the pressing chamber outlet, thereby maintaining a selected predetermined dryness of solids exiting the pressing chamber outlet.

15. A press according to claim 1 wherein the conveyor system includes an opposed pair of conveyor belts comprising a plurality of links, said belts driven by respective sprocket wheels, the teeth of which both drive the belts and clean solids from the belts.

16. A press according to claim 1 wherein the at least one pair of opposing surfaces of the conveyor has a plurality of protrusions, thereby preventing blinding.

17. A press according to claim 1 wherein gas injecting means are provided, enabling control of the pressing chamber atmosphere.

18. A solids removal press feed system for a solids removal press, the press having:
a conveyor system having at least one pair of opposing surfaces defining a pressing chamber, the pressing chamber having an inlet opening at one end thereof and a discharge opening at the other end thereof;
at least part of the pressing chamber being permeable to liquid, enabling collection of liquid from the pressing chamber;
the conveyor system conveying the mixture through the pressing chamber towards the discharge opening;
wherein the pressing chamber includes at least one pressing zone; wherein the inlet opening enables the pressing chamber to be in fluid communication with a feed system for providing a continuous, pressurized, feed of the liquid and solids mixture to the pressing chamber; and wherein the feed system includes director means for directing a flow of the mixture through an inlet opening of the press and generally along at least one surface of the conveyor system, the directed flow thereby urging agglomerating solids towards the discharge opening of the press.

19. A feed system according to claim 18 wherein the feed system directs the flow of the mixture generally along and at an angle of incidence of less than 60 degrees with the at least one surface of the press conveyor system such that agglomerating solids are urged towards a press discharge opening.

20. A feed system according to claim 18 wherein the feed system directs the flow of the mixture generally along and substantially parallel with the at least one surface of the press conveyor system.

21. A method of removing solids from a liquid and solids mixture, using a solids removal press having:
a conveyor system having at least one pair of opposing surfaces defining a pressing chamber, the pressing chamber having an inlet opening at one end thereof and a discharge opening at the other end thereof;
at least part of the pressing chamber being permeable to liquid, enabling collection of liquid from the pressing chamber;
the conveyor system conveying the mixture through the pressing chamber towards the discharge opening;
wherein the pressing chamber includes at least one pressing zone; the inlet opening enabling the pressing chamber to be in fluid communication with a feed system for providing a continuous, pressurized, feed of the liquid and solids mixture to the pressing chamber and directing a flow of the mixture generally along at least one surface of the conveyor system, the directed flow thereby urging agglomerating solids towards the discharge opening of the press.
